(19) United States
(12) Patent Application Publication
(10) Pub. No.: US 2010/0247936 A1
(43) Pub. Date: Sep. 30, 2010

(54) NON-PVC FILMS WITH TOUGH CORE LAYER

(75) Inventors: Moh-Ching Oliver Chang, Lake In The Hills, IL (US); Yuanpang S. Ding, Libertyville, IL (US); Michael Tung-Kiung Ling, Vernon Hills, IL (US); John W. Putnam, Lindenhurst, IL (US); Dan Liu, Buffalo Grove, IL (US); Fabio Giuseppe Casartelli, Delebio, Sondrio (IT); Robert R. Roberts, Burlington, WI (US); Gregg Nebgen, Burlington, WI (US); Annick Colin, Waterloo (BE); Giampiero Pesci, Tirano, Sondrio (IT)

Correspondence Address: K&L Gates LLP, P.O. Box 1135, Chicago, IL, 60690-1135, US

(73) Assignees: BAXTER INTERNATIONAL INC., Deerfield, IL (US); BAXTER HEALTHCARE S.A., Zurich (CH)

(21) Appl. No.: 12/409,646

(22) Filed: Mar. 24, 2009

(51) Int. Cl. B32B 27/00; B32B 27/08; B32B 27/36; B65D 30/08

(52) U.S. Cl. 428/476.3; 428/500; 428/515; 428/483; 383/109

(57) ABSTRACT

Multilayer films comprising a core layer are provided. In an embodiment, the present disclosure provides a film having a core layer comprising a material selected from a rubber-modified polypropylene and a polymer blend. The polymer blend includes an elastomeric propylene-ethylene copolymer and a component selected from the group consisting of polypropylene random copolymers, styrene/ethylene-butylene/styrene block copolymers, and combinations thereof.

### BACKGROUND

The present disclosure relates generally to polymer films. More particularly, the present disclosure relates to non-PVC polymer films comprising novel core layers.

Multilayer coextruded films are widely used throughout a variety of industries, for example, including use in containers for food or medical solution packaging. One of the desired properties of a multilayer coextruded film is its toughness or ability to resist damage in use or transport. Another desired property, particularly in medical solution container films, is the ability to make both a peel seal at the desired strength to suit the application as well as a permanent seal to permanently enclose a container. An additional desired property is to provide a barrier to gases such as oxygen, carbon dioxide or water vapor in order to maintain the stability of contained solutions.

Traditional flexible polyvinyl chloride materials have also typically been used to fabricate medical grade containers. Polyvinyl chloride (“PVC”) is a cost effective material for constructing such devices. However, PVC may generate objectionable amounts of hydrogen chloride (or hydrochloric acid when contacted with water) upon incineration. Flexible PVC contains plasticizers, which have been alleged to leach into drugs or biological fluids or tissues that come in contact with PVC formulations.

### SUMMARY

The present disclosure generally relates to films having a tough core layer. In an embodiment, a multilayer film includes a skin layer, a seal layer, and a core layer disposed between the skin layer and the seal layer. The core layer includes a material selected from a rubber-modified polypropylene and a polymer blend. The polymer blend includes an elastomeric propylene-ethylene copolymer and a component selected from the group consisting of polypropylene random copolymer, styrene/ethylene-butylene/styrene block copolymer, and combinations thereof.

In an embodiment, the core layer includes a polymer blend including about 70% to about 90% by weight of the elastomeric propylene-ethylene copolymer and about 10% to about 30% by weight of the component selected from the group consisting of polypropylene random copolymer, styrene/ethylene-butylene/styrene block copolymer, and combinations thereof. The core layer may also include a rubber-modified polypropylene.

In an embodiment, the multilayer film has a dart normalized impact energy greater than 6 J/mm according to ASTM D3763. The multilayer film may have less than 20% haze when wetted on a first side. The multilayer film may be heat sealed into a container having seals wherein the seals remain intact when the container is autoclaved at 121° C. for one hour. The multilayer film may provide a peel seal between 4 N/15 mm and 30 N/15 mm.

In an embodiment, the skin layer includes a component selected from the group consisting of polypropylene random copolymer, polypropylene homopolymer, nylon, styrene/ethylene-butylene/styrene block copolymer, copolyester ether block copolymer, and combinations thereof. The skin layer may include a blend comprising about 90% by weight polypropylene random copolymer and about 10% by weight styrene/ethylene-butylene/styrene block copolymer. Alternatively, the skin may include about 45% polypropylene homopolymer, 50% thermoplastic elastomer, and about 5% high melt strength PP. The skin layer may include a copolyester ether block copolymer.

In an embodiment, the seal layer includes at least one component selected from polypropylene random copolymer, linear low-density polyethylene, styrene/ethylene-butylene/styrene block copolymer, rubber-modified polypropylene, and mixtures thereof. For example, the seal layer may include a blend of polypropylene random copolymer, linear low-density polyethylene, and styrene/ethylene-butylene/styrene block copolymer.

In an embodiment, a barrier layer is disposed between the skin layer and the seal layer. The barrier layer may include a component selected from the group consisting of polyamides (nylons) such as polyamide 6,6/6,10 copolymers, polyamide 6, amorphous polyamides, and blends thereof, or ethylene vinyl alcohol copolymers. The multilayer film may provide a CO₂ permeability of less than 200 cm³/m² day atm.

In an embodiment, the multilayer film includes a first tie layer and a second tie layer. The barrier layer is disposed between and in contact with the first tie layer and the second tie layer. The first and second tie layers may each include a component selected from the group consisting of maleated LLDPE, maleated polypropylene homopolymer, maleated polypropylene copolymer, maleated thermoplastic elastomer, or rubber modified polypropylene, and combinations thereof.

In another embodiment, a multilayer film includes a skin layer, a first tie layer, a barrier layer disposed adjacent the first tie layer, a second tie layer disposed adjacent the barrier layer, a core layer, and a seal layer. The core layer includes a material selected from a rubber-modified polypropylene and a polymer blend. The polymer blend includes elastomeric propylene-ethylene copolymer and at least one component selected from the group consisting of polypropylene random copolymer, styrene/ethylene-butylene/styrene block copolymer, and combinations thereof. The core layer may be disposed adjacent to and in contact with the seal layer. Alternatively, the core layer may be disposed adjacent to and in contact with the skin layer.

In an embodiment, a fluid container includes a first sidewall and a second sidewall sealed together along at least one peripheral edge to define a fluid chamber. (As used herein, the term fluid or flowable material includes not only liquids and gases but also flowable solids such as powders, as well as combinations thereof such as suspensions.) At least one of the first and second sidewall is a film having at least one layer including a blend including about 70% to about 90% by weight of an elastomeric propylene-ethylene copolymer and about 10% to about 30% by weight of a component selected from the group consisting of polypropylene random copolymer, styrene/ethylene-butylene/styrene block copolymer, and combinations thereof.

In another embodiment, a fluid container includes a first sidewall and a second sidewall sealed together along at least one peripheral edge to define a fluid chamber. At least one of the first and second sidewall includes a multilayer film. The multilayer film includes a skin layer, a seal layer, and a core layer disposed between the skin layer and the seal layer. The core layer includes a material selected from a rubber-modified polypropylene and a polymer blend. The polymer blend includes an elastomeric propylene-ethylene copolymer and at least one component selected from the group consisting of polypropylene random copolymer, styrene/ethylene-butylene/styrene block copolymer, and combinations thereof.

In another embodiment, a fluid container includes a first sidewall and a second sidewall sealed together along at least one peripheral edge to define a fluid chamber. At least one of the first and second sidewalls includes a multilayer film. The multilayer film includes a skin layer, a first tie layer, a barrier layer disposed adjacent the first tie layer, a second tie layer disposed adjacent the barrier layer, a core layer, and a seal layer. The core layer includes a material selected from a rubber-modified polypropylene and a polymer blend. The polymer blend includes an elastomeric propylene-ethylene copolymer and at least one component selected from the group consisting of polypropylene random copolymer, styrene/ethylene-butylene/styrene block copolymer, and combinations thereof.

Additional features and advantages are described herein, and will be apparent from the following Detailed Description and the figures.

### BRIEF DESCRIPTION OF THE FIGURES

FIG. 1 illustrates a cross-sectional view of an embodiment of a three-layer film.

FIG. 2 illustrates a cross-sectional view of an embodiment of a six-layer film.

FIG. 3 illustrates a cross-sectional view of another embodiment of a six-layer film.

FIG. 4 illustrates an embodiment of a container constructed from a film of the present disclosure.

### DETAILED DESCRIPTION

The present disclosure provides non-PVC films that have desirable properties, including good toughness, low haze, and heat resistance at 121° C. The disclosure provides monolayer films as well as multilayer films useful for packaging applications.

Films that have good toughness, low haze, heat resistance and a reasonable raw material cost are desirable for a variety of industries, including containers for food or medical solution packaging. Sterilization processes suitable for medical solutions usually include the step of exposing the container to steam at temperatures typically greater than 121° C. and at elevated pressures. Additionally, for ease of manufacture into useful articles, it is desirable that the material be heat sealable. The material therefore must maintain sufficient thermoplastic properties to melt upon heating.

Non-PVC film products that are required to go through sterilization at 121° C. generally have used polyolefin materials, such as polypropylene and polyethylene, with melting temperatures greater than 121° C. However, these materials are inherently somewhat stiff and have low toughness and damage resistance for container applications. One approach to improving the toughness of these films is to use elastomeric materials. However, elastomeric materials usually have melting points too low to allow them to be autoclaved. The present disclosure provides films with good material properties as well as sufficient heat resistance to allow them to be autoclaved.

A monolayer film made from a polymer blend has been found to have good properties, including toughness, clarity, autoclavability, and stiffness. The polymer blend includes two components. The first component is an elastomeric propylene-ethylene copolymer, which provides elasticity and flexibility. The second component may be a polypropylene random copolymer, a styrene/ethylene-butylene/styrene block copolymer, or a combination thereof. The blend may include about 70% to about 90% by weight of the elastomeric propylene-ethylene copolymer and about 10% to about 30% by weight of the blend of the second component. For example, the blend may include between about 5% and about 20% by weight of the polypropylene random copolymer and/or between about 2% and about 16% by weight of the styrene/ethylene-butylene/styrene block copolymer. The blend may include additional components, or may substantially only include the first component and the second component. Further specific formulations of the polymer blend for the monolayer film are discussed in the Examples below.

Suitable elastomeric propylene-ethylene copolymers include, but are not limited to, Dow VERSIFY DE3300 and DE3401 and Exxon VISTAMAXX 1100 and VISTAMAXX 6102. Suitable polypropylene random copolymers include Huntsman 43M5A and Borealis TOTAL 8573. A suitable styrene/ethylene-butylene/styrene block copolymer is Kraton G1643.

Monolayer films made from the above formulation have acceptable toughness, clarity, autoclavability, and stiffness or modulus. The films have acceptable film surface appearance, i.e., no blistering or waviness after autoclaving. In particular, the monolayer films have a dart normalized impact energy greater than 12 J/mm when measured according to ASTM D3763. Further, the monolayer films have less than 10% haze according to ASTM D1003 when wetted on both sides. The monolayer films may be used by themselves or as part of a multilayer film.

The present disclosure also provides multilayer films. Multilayer films are widely used throughout a variety of industries, including containers for food or medical solution packaging. Some desired properties of a multilayer coextruded film for medical solution applications include (a) toughness or ability to resist damage in use or transport; (b) the ability to make both a peel seal at the desired strength to suit the application as well as a permanent seal to permanently enclose a container; and (c) the ability to act as a barrier to gases such as oxygen, carbon dioxide or water vapor in order to maintain the stability of contained solutions. The present disclosure provides a dimensionally stable multilayer film with improved toughness through the addition of a tough core layer, while maintaining good gas barrier and peel seal properties.

Previous multilayer films with both barrier and peel seal capability have been developed for many applications. However, such films have been limited in certain applications by low toughness, due to the relatively brittle layers required for barrier properties. It has been found that the properties of multilayer films may be improved by including a relatively thick tough core layer in the structure in addition to the barrier layer.

In particular, it has been found that by providing a core layer in a multilayer film, the multilayer film has improved toughness or ability to absorb impact energy. The multilayer films disclosed herein are sterilizable at 121° C. and have a low haze. The multilayer films may also include a gas barrier layer and may be peel-sealable using heat sealing machinery. Unlike prior films, it is not required that the films of the present disclosure be crosslinked by the use of an electron beam or other methods.

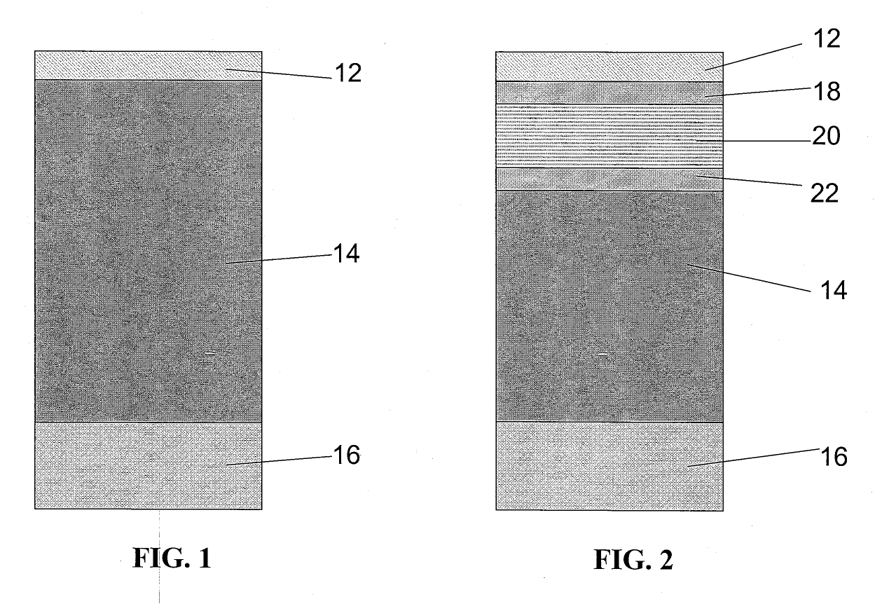

FIG. 1 illustrates a cross-sectional view of an embodiment of a three-layer film. The multilayer film includes an outer skin layer 12, a core layer 14, and an outer seal layer 16. The composition of the core layer 14 may be the same as that of the previously described monolayer films.

FIG. 2 illustrates a cross-sectional view of an embodiment of a six-layer film. The multilayer film includes an outer skin layer 12, a first tie layer 18, a barrier layer 20, a second tie layer 22, a core layer 14, and an outer seal layer 16.

The core layer provides toughness and impact resistance to the film. The core layer may be a blend of two components, where the first component is an elastomeric propylene-ethylene copolymer and the second component may be a polypropylene random copolymer, a thermoplastic elastomer such as a styrene/ethylene-butylene/styrene block copolymer, or a combination thereof. The core layer may also include a rubber-modified polypropylene (a blend of polypropylene with a rubber such as SEBS, SBS, SEPS, SEEPS, EP or EPDM). A typical thickness for the core layer is 4 mils to 7 mils.

Suitable elastomeric propylene-ethylene copolymers include those sold by Exxon under the VISTAMAXX trade name and by Dow under the VERSIFY 3000 trade name. Suitable polypropylene random co-polymers include those sold by Flint Hills Resources under the HUNTSMAN trade name and Borealis under the BOREALIS and TOTAL trade names. Suitable styrene-ethylene-butylene-styrene block copolymers include those sold by Kraton Polymers under the KRATON trade name. Suitable ethylene-propylene rubber-modified polypropylene elastomers include those sold by Mitsubishi under the ZELAS trade name.

The skin layer provides abrasion and scuff resistance to the film. In general, the skin layer may be polypropylene (homopolymer or copolymer), a blend of several polypropylenes, blend of polypropylene(s) with rubber such as SEBS or SBS and polyethylene, nylon, styrene/ethylene-butylene/styrene block copolymer, copolyester ether block copolymer, or a combination thereof. In one embodiment, the skin may include about 45% polypropylene homopolymer, 50% polypropylene thermoplastic elastomer, and about 5% high melt strength PP. A typical thickness for the skin layer is 0.5 mils to 2.0 mils.

The seal layer provides a permanent or temporary seal between two films so that, for example, a container may be formed from the films. The seal layer may include a blend of polypropylene random copolymer, linear low-density polyethylene, and styrene/ethylene-butylene/styrene block copolymer. In one embodiment, the seal layer includes a blend comprising about 60% by weight polypropylene random copolymer, about 15% by weight linear low-density polyethylene, and about 25% by weight styrene/ethylene-butylene/styrene block copolymer. A typical thickness for the seal layer is 1.0 mils to 3.5 mils.

Suitable polypropylene random co-polymers include those sold by Flint Hills Resources under the HUNTSMAN trade name and Borealis under the BOREALIS and TOTAL trade names. Suitable styrene-ethylene-butylene-styrene block copolymers include those sold by Kraton Polymers under the KRATON trade name. Suitable LLDPEs include those sold by Exxon under the EXXON trade name and Dow under the DOWLEX trade name.

The barrier layer provides a barrier to gases, especially CO₂. The barrier layer may be any suitable polyamide or other material, including polyamide 6,6/6,10 copolymer, polyamide 6, amorphous polyamides, ethylene vinyl alcohol copolymers, and combinations thereof. Suitable polyamides include those sold by EMS under the GRIVORY and GRILON trade names. Suitable ethylene vinyl alcohols include those sold by Evalca under the EVAL trade name. A typical thickness for the barrier layer is 1.0 mils to 2.0 mils.

The tie layers surround the barrier layer to provide a compatible interface with the other film layers. The tie layers may be maleated LLDPE, maleated polypropylene homopolymer, maleated polypropylene copolymer, (maleated TPO or rubber modified PP) or combinations thereof. Suitable maleated LLDPE materials include those sold by DuPont under the BYNEL trade name. Suitable maleated polypropylene homo-polymers include those sold by Mitsui under the ADMER trade name. Suitable maleated polypropylene copolymers include those sold by Mitsubishi under the MODIC trade name. A typical thickness for the tie layers is 0.2 mils to 0.5 mils.

The dart normalized impact energy for the multilayer film is preferably greater than 6 J/mm in normalized energy at max. As used herein, the term “normalized energy at max” refers to the energy calculated as the area under the portion of a force-displacement curve to the left of the maximum, where the curve is generated in accordance with ASTM D-3763. In addition the films preferably have less than 20% haze when wetted on one side. The films may be capable of providing a peel seal having a strength between 4N/15 mm and 30N/15 mm at sealing temperatures greater than 122° C. using heated dies. For films with a barrier layer, the film preferably has a CO₂ permeability less than 200 cm³/m² day atm.

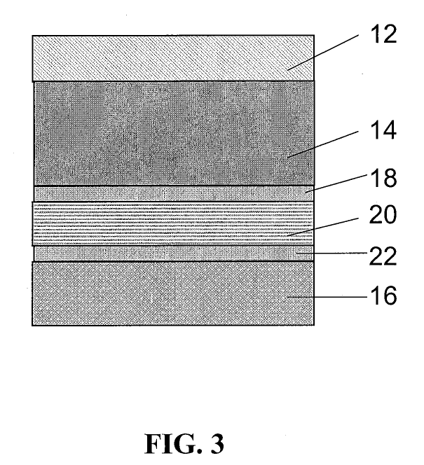

FIG. 3 illustrates a cross-sectional view of an embodiment of a six-layer film. The multilayer film includes a skin layer 12, core layer 14, a first tie layer 18, a barrier layer 20, a second tie layer 22, and a seal layer 16. In previous containers with a peel seal, it had been found that the film had a tendency to tear at the peel seal. It has been found that by moving the core layer 14 adjacent to the skin layer 12 (instead of the seal layer 16, as shown in the embodiment in FIG. 2), tearing is reduced in the film.

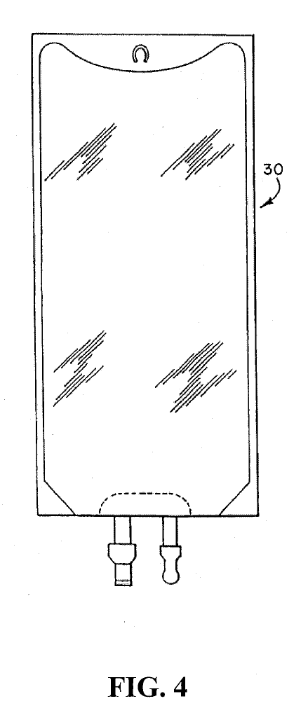

The above-described monolayer and multilayer films may be used to form a container, such as a medical fluid container. FIG. 4 illustrates a medical fluid container 30 constructed from a film of the present disclosure. The sidewalls may be permanently sealed together along at least one peripheral edge to define a fluid chamber. The sidewalls of the container 30 may be fabricated from any of the monolayer or multilayer films described herein. The container 30 may include a peel seal or a permanent seal. The container 30 may also comprise two or more chambers separated, for example, by a peel seal or a permanent seal.

To produce the films of the present disclosure, raw materials are fed into an extrusion hopper at the desired mix ratio employing weight feeders. The materials are extruded using an extrusion die to produce a monolayer or multilayer film. The films may be cast or blown. The film may be sealed to form a fluid container. The raw materials may be pre-compounded before extrusion employing a single screw, twin screw or other compounding methods familiar to those skilled in the art.

### EXAMPLES

By way of example and not limitation, the following examples are illustrative of various embodiments of the present disclosure.

### Monolayer Films

A variety of monolayer films were prepared using the formulations shown below in Tables 1-6. The resulting structures were then tested for impact strength, haze, and tensile strength. Toughness or impact energy was measured using the ASTM D3763 “High Speed Puncture Properties of Plastics Using Load and Displacement Sensors” and/or functional container drop testing.

The results for a first series of monolayer films are shown in Tables 1 and 2. The films had acceptable film surface appearance, i.e., no blistering or waviness after autoclaving, possessed good toughness (normalized energy at max generally greater than 10 J/mm) and superior clarity (haze less than 10% when film wetted on both sides) when not sterilized.

TABLE 1
Formulation and Impact Data

| | 26-3 | 26-4 | 26-6 | 26-7 | 26-10 | 26-16 | 26-17 | 26-18 | 26-20 | 26-21 |
|---|---|---|---|---|---|---|---|---|---|---|
| Formulation | | | | | | | | | | |
| Versify DE3300 | 83.3% | 71.4% | 83.3% | 71.4% | 0.0% | 0.0% | 0.0% | 0.0% | 0.0% | 0.0% |
| Versify DE3401 | 0.0% | 0.0% | 0.0% | 0.0% | 83.3% | 0.0% | 0.0% | 0.0% | 0.0% | 0.0% |
| Vistamaxx 1100 | 0.0% | 0.0% | 0.0% | 0.0% | 0.0% | 83.3% | 83.3% | 71.4% | 83.3% | 71.4% |
| Huntsman 43M5A | 16.7% | 14.3% | 8.3% | 14.3% | 16.7% | 8.3% | 16.7% | 14.3% | 8.3% | 14.3% |
| Kraton G1643 | 0.0% | 14.3% | 8.3% | 14.3% | 0.0% | 8.3% | 0.0% | 14.3% | 8.3% | 14.3% |
| Surface App. After | OK | OK | OK | OK | OK | OK | OK | OK | OK | OK |
| Autoclaving | | | | | | | | | | |
| Impact, RT | | | | | | | | | | |
| (Unsterilized) | | | | | | | | | | |
| Thickness (mil) | 7.8 | 8.3 | 8.0 | 7.2 | 8.0 | 7.8 | 8.3 | 7.7 | 7.9 | 8.3 |
| Maximum load, kN | 0.1 | 0.1 | 0.1 | 0.1 | 0.1 | 0.1 | 0.1 | 0.1 | 0.1 | 0.1 |
| Energy to F, J | 4.2 | 4.4 | 3.8 | 3.4 | 3.0 | 1.9 | 3.5 | 2.2 | 1.8 | 3.0 |
| Norm. energy at | 17.0 | 16.0 | 14.1 | 14.8 | 12.8 | 9.4 | 12.6 | 10.9 | 8.9 | 11.2 |
| Max, J/mm | | | | | | | | | | |
| Norm. energy at F, | 21.3 | 20.7 | 18.9 | 18.6 | 14.8 | 9.6 | 16.4 | 11.5 | 9.2 | 14.4 |
| J/mm | | | | | | | | | | |
| Deflection at max | 56.7 | 56.4 | 55.7 | 55.7 | 55.5 | 54.5 | 56.1 | 55.0 | 54.1 | 55.3 |
| load, mm | | | | | | | | | | |
| Deflection at F, mm | 73.9 | 76.3 | 78.7 | 73.2 | 66.0 | 55.6 | 76.2 | 58.0 | 55.9 | 72.6 |

TABLE 2
Haze and Tensile Data

| | 26-3 | 26-4 | 26-6 | 26-7 | 26-10 | 26-16 | 26-17 | 26-18 | 26-20 | 26-21 |
|---|---|---|---|---|---|---|---|---|---|---|
| Haze | | | | | | | | | | |
| (Unsterilized) | | | | | | | | | | |
| Haze (dry), % | 2.9 | 3.4 | 2.4 | 2.9 | 9.2 | 34.4 | 27.6 | 22.5 | 32.4 | 27.5 |
| Haze (wet on | 2.0 | 2.6 | 2.1 | 2.6 | 6.7 | 20.2 | 17.6 | 13.0 | 20.8 | 17.8 |
| seal-side), % | | | | | | | | | | |
| Haze (wet on | 1.1 | 2.0 | 1.3 | 1.4 | 3.1 | 2.5 | 2.4 | 1.8 | 3.0 | 2.2 |
| both sides), % | | | | | | | | | | |
| Tensile | | | | | | | | | | |
| (Unsterilized) | | | | | | | | | | |
| Young's Modulus | 6976 | 5620 | 3425 | 4086 | 2288 | 2130 | 4141 | 2369 | 2251 | 2445 |
| (psi) | | | | | | | | | | |
| Yield Elong (Z- | 33.6 | 41.9 | 38.8 | 37.8 | 47.4 | 51.3 | 38.2 | 52.5 | 53.5 | 54 |
| Slp %) | | | | | | | | | | |
| Yield Strength | 680 | 608 | 466 | 513 | 416 | 309 | 449 | 348 | 312 | 395 |
| (Z-Slp psi) | | | | | | | | | | |
| Tensile Strength | 2322 | 2478 | 1615 | 1757 | 1562 | 2315 | 1561 | 1261 | 2410 | 2757 |
| Break Ext (in) | 17.0 | 18.2 | 15.3 | 15.3 | 15.8 | 18.2 | 13.8 | 13.3 | 18.3 | 19.1 |
| Tensile Elong | 595 | 634 | 586 | 558 | 590 | 655 | 505 | 496 | 695 | 669 |
| (%) | | | | | | | | | | |

The results for a second series of monolayer films are shown in Tables 3 and 4. These films had good toughness (normalized energy at max greater than 12 J/mm) and superior clarity (haze less than 10% when film wetted on both sides) both before and after autoclaving.

TABLE 3
Formulation and Impact Data

| | 27-2 | 27-3 | 27-4 | 27-5 | 27-6 | 63-2 |
|---|---|---|---|---|---|---|
| Formulation | | | | | | |
| Versify | 0.0% | 0.0% | 0.0% | 0.0% | 0.0% | 0.0% |
| DE3300 | | | | | | |
| Vistamaxx | 80.0% | 80.0% | 83.3% | 76.9% | 76.9% | 0.0% |
| 1100 | | | | | | |
| Vistamaxx | 0.0% | 0.0% | 0.0% | 0.0% | 0.0% | 76.9% |
| 6102 | | | | | | |
| Huntsman | 20.0% | 0.0% | 16.7% | 23.1% | 19.2% | 19.2% |
| 43M5A | | | | | | |
| Total 8573 | 0.0% | 20.0% | 0.0% | 0.0% | 0.0% | 0.0% |
| Kraton G1643 | 0.0% | 0.0% | 0.0% | 0.0% | 3.8% | 3.8% |
| Impact, RT | | | | | | |
| (Unsterilized) | | | | | | |
| Maximum | 0.064 | 0.065 | 0.062 | 0.070 | 0.066 | 0.074 |
| load, kN | | | | | | |
| Energy to F, J | 2.02 | 1.99 | 1.90 | 2.29 | 2.12 | 2.30 |
| Norm. energy | 14.9 | 14.2 | 12.5 | 14.9 | 14.4 | 11.8 |
| at Max, J/mm | | | | | | |
| Norm. energy | 15.3 | 14.4 | 12.7 | 15.4 | 14.9 | 12.1 |
| at F, J/mm | | | | | | |
| Deflection at | 56.0 | 55.6 | 55.3 | 55.9 | 55.5 | 55.1 |
| max load, mm | | | | | | |
| Deflection at F, | 57.4 | 56.4 | 56.3 | 58.1 | 57.2 | 56.2 |
| mm | | | | | | |
| Impact, RT | | | | | | |
| (autoclaved) | | | | | | |
| Maximum | 0.072 | 0.074 | 0.073 | 0.075 | 0.073 | 0.084 |
| load, kN | | | | | | |
| Energy to F, J | 2.01 | 2.38 | 2.32 | 1.94 | 2.14 | 2.49 |
| Norm. energy | 13.2 | 15.0 | 14.3 | 12.1 | 14.2 | 13.4 |
| at Max, J/mm | | | | | | |
| Norm. energy | 13.6 | 15.5 | 15.1 | 12.5 | 14.5 | 13.8 |
| at F, J/mm | | | | | | |
| Deflection at | 48.2 | 55.1 | 55.1 | 44.5 | 50.1 | 55.1 |
| max load, mm | | | | | | |
| Deflection at F, | 49.1 | 57.0 | 58.0 | 45.6 | 50.9 | 56.8 |
| mm | | | | | | |
| Morphology | Ductile | Ductile | Ductile | Ductile | Ductile | Ductile |

TABLE 4
Haze and Tensile Data

| | 27-2 | 27-3 | 27-4 | 27-5 | 27-6 | 63-2 |
|---|---|---|---|---|---|---|
| Haze | | | | | | |
| (Unsterilized) | | | | | | |
| Haze (dry), % | 4.3 | 7.0 | 11.2 | 9.3 | 7.8 | 26.2 |
| Haze (wet on | 2.2 | 4.3 | 6.8 | 5.8 | 4.2 | 17.5 |
| seal-side), % | | | | | | |
| Haze (wet on | 1.0 | 0.7 | 1.2 | 1.2 | 1.1 | 2.8 |
| both sides), % | | | | | | |
| Haze | | | | | | |
| (Autoclaved) | | | | | | |
| Haze (dry), % | 10.4 | 24.9 | 32.6 | 13.9 | 23.3 | 34.7 |
| Haze (wet on | 7.3 | 13.4 | 16.0 | 8.6 | 14.2 | 25.5 |
| seal-side), % | | | | | | |
| Haze (wet on | 4.2 | 4.4 | 6.0 | 4.4 | 3.2 | 6.4 |
| both sides), % | | | | | | |
| Tensile | | | | | | |
| (Unsterilized), | | | | | | |
| TD | | | | | | |
| Young's | 6392 | 5309 | 3801 | 8266 | 6104 | NM |
| Modulus (psi) | | | | | | |
| Yield Elong | 32.5 | 38.3 | 35.7 | 30.5 | 35.9 | NM |
| (Z-Slp %) | | | | | | |
| Yield Strength | 642 | 629 | 471 | 679 | 617 | NM |
| (Z-Slp psi) | | | | | | |
| Tensile | 2487 | 3032 | 2224 | 3564 | 2500 | NM |
| Strength | | | | | | |
| Tensile Elong | 475 | 568 | 537 | 630 | 558 | NM |
| (%) | | | | | | |
| Tensile | | | | | | |
| (Autoclaved), | | | | | | |
| TD | | | | | | |
| Young's | 4706 | 2766 | 2325 | 7585 | 4261 | 1640 |
| Modulus (psi) | | | | | | |
| Yield Elong | 44.1 | 60.3 | 56.7 | 36.1 | 49.2 | 33.3 |
| (Z-Slp %) | | | | | | |
| Yield Strength | 842 | 730 | 621 | 923 | 883 | 219 |
| (Z-Slp psi) | | | | | | |
| Tensile | 3463 | 4044 | 3209 | 4041 | 4341 | 1969 |
| Strength | | | | | | |
| Tensile Elong | 640 | 793 | 765 | 652 | 752 | 807 |
| (%) | | | | | | |

The results for a third series of monolayer films are shown in Tables 5 and 6. These films had good toughness (normalized energy at max greater than 12 J/mm) and superior clarity (haze less than 10% when film wetted on both sides) after autoclaving.

TABLE 5
Formulation and Impact Data

| | 29-1 | 29-3 | 29-4 | 29-5 | 29-6 | 29-7 |
|---|---|---|---|---|---|---|
| Formulation | | | | | | |
| Vistamaxx | 80.0% | 76.9% | 76.9% | 74.1% | 83.3% | 80.0% |
| 1100 | | | | | | |
| Huntsman | 0.0% | 0.0% | 0.0% | 0.0% | 0.0% | 16.0% |
| 43M5A | | | | | | |
| Total 8573 | 20.0% | 19.2% | 23.1% | 22.2% | 16.7% | 0.0% |
| Kraton | 0.0% | 3.8% | 0.0% | 3.7% | 0.0% | 4.0% |
| G1643 | | | | | | |
| Zelas MC717 | 0.0% | 0.0% | 0.0% | 0.0% | 0.0% | 0.0% |
| Impact | | | | | | |
| (Autoclaved) | | | | | | |
| Thickness | 6.0 | 5.9 | 5.9 | 5.7 | 5.7 | 6.2 |
| (mil) | | | | | | |
| Maximum | 0.1 | 0.1 | 0.1 | 0.1 | 0.1 | 0.1 |
| load, kN | | | | | | |
| Energy to F, J | 2.2 | 2.2 | 2.0 | 2.0 | 1.9 | 2.6 |
| Norm. | 14.1 | 13.9 | 12.9 | 13.4 | 12.8 | 16.0 |
| energy at | | | | | | |
| Max, J/mm | | | | | | |
| Norm. | 14.6 | 14.6 | 13.2 | 13.9 | 13.3 | 16.6 |
| energy at F, | | | | | | |
| J/mm | | | | | | |
| Deflection at | 51.0 | 53.6 | 46.8 | 48.3 | 54.6 | 55.6 |
| max load, | | | | | | |
| mm | | | | | | |
| Deflection at | 52.3 | 56.1 | 47.7 | 49.6 | 56.4 | 57.8 |
| F, mm | | | | | | |

TABLE 6
Haze and Tensile Data

| | 29-1 | 29-3 | 29-4 | 29-5 | 29-6 | 29-7 |
|---|---|---|---|---|---|---|
| Haze | | | | | | |
| (Autoclaved) | | | | | | |
| Haze (dry), % | 25.8 | 32.4 | 29.5 | 31.4 | 17.8 | 33.1 |
| Haze (wet on | 13.7 | 20.8 | 15.6 | 25.5 | 10.1 | 25.1 |
| seal-side), % | | | | | | |
| Haze (wet on | 3.7 | 6.5 | 4.9 | 5.2 | 3.1 | 6.7 |
| both sides), % | | | | | | |
| Tensile | | | | | | |
| (Autoclaved), | | | | | | |
| TD | | | | | | |
| Young's | 5333 | 2247 | 3876 | 3664 | 1784 | 4627 |
| Modulus | | | | | | |
| (psi) | | | | | | |
| Yield Elong | 40.2 | 67.2 | 46.6 | 50.9 | 75.1 | 43.9 |
| (Z-Slp %) | | | | | | |
| Yield | 836 | 704 | 804 | 832 | 651 | 866 |
| Strength (Z- | | | | | | |
| Slp psi) | | | | | | |
| Tensile | 2613 | 3209 | 1772 | 2418 | 2661 | 1986 |
| Strength | | | | | | |
| Tensile | 544 | 677 | 371 | 537 | 590 | 394 |
| Elong (%) | | | | | | |

### Multilayer Films Example A

A series of three-layer films were prepared with the configuration shown in FIG. 1. Example V-1 included a tough core layer along with a seal layer developed to be tough and span a large range of peel forces to meet differing container peel requirements. Example V-2 included tough core layers along with permanent seal layers for applications where a peel seal is not required. Examples V-3 and V-4 provided peel and permanent sealing. Examples V-5 and V-6 provided permanent sealing. The results of impact testing and haze are shown in Table 8. The results show that both the V-1 and V-2 films had good impact toughness with normalized energy at max greater than 8 J/mm and a superior clarity with a haze at about 10% when the seal side surface is wetted.

TABLE 7
Formulation Data

| | V-1 | V-2 | V-3 | V-4 | V-5 | V-6 |
|---|---|---|---|---|---|---|
| Skin layer | 90% PP | 90% PP | 90% PP | Ecdel PCCE | 90% PP | Ecdel PCCE |
| | Huntsman | Huntsman | Huntsman | 9966, 0.5 mil | Huntsman | 9966, 0.5 mil |
| | 43M5A | 43M5A | 43M5A | | 43M5A | |
| | 10% SEBS | 10% SEBS | 10% SEBS | | 10% SEBS | |
| | Kraton G1643, | Kraton G1643, | Kraton G1643, | | Kraton G1643, | |
| | 0.5 mil | 0.6 mil | 0.5 mil | | 0.5 mil | |
| Tie layer | None | None | Admer 510, 0.4 | Bynel 4109, 0.4 | Admer 510, 0.4 | Bynel 4109, 0.4 |
| | | | mil | mil | mil | mil |
| Barrier layer | None | None | EMS Grilon | EMS Grilon | EMS Grilon | EMS Grilon |
| | | | FG40NL, 1.1 mil | FG40NL, 1.1 mil | FG40NL, 1.1 mil | FG40NL, 1.1 mil |
| Tie layer | None | None | Admer 510, 0.4 | Bynel 4109, 0.4 | Admer 510, 0.4 | Bynel 4109, 0.4 |
| | | | mil | mil | mil | mil |
| Core layer | 83% Vistamax | 83% Vistamax | 83% Vistamax | 83% Vistamax | 83% Vistamax | 83% Vistamax |
| | 1100 | 1100 | 1100 | 1100 | 1100 | 1100 |
| | 17% PP | 17% PP | 17% PP | 17% PP | 17% PP | 17% PP |
| | Huntsman | Huntsman | Huntsman | Huntsman | Huntsman | Huntsman |
| | 43M5A, | 43M5A, | 43M5A, | 43M5A, | 43M5A, | 43M5A, |
| | 6.0 mil | 6.5 mil | 4.0 mil | 4.0 mil | 4.0 mil | 4.0 mil |
| Seal layer | 60% PP | 90% PP Total | 60% PP | 60% PP | 90% PP Total | 90% PP Total |
| | Huntsman | 8573 | Huntsman | Huntsman | 8573 | 8573 |
| | 43M5A | 10% SEBS | 43M5A | 43M5A | 10% SEBS | 10% SEBS |
| | 15% LLDPE | Kraton G1643, | 15% LLDPE | 15% LLDPE | Kraton G1643, | Kraton G1643, |
| | Exxon LL3003 | 1.0 mil | Exxon LL3003 | Exxon LL3003 | 1.5 mil | 1.5 mil |
| | 25% SEBS | | 25% SEBS | 25% SEBS | | |
| | Kraton G1643, | | Kraton G1643, | Kraton G1643, | | |
| | 1.5 mil | | 1.5 mil | 1.5 mil | | |

TABLE 8
Impact and Haze Data

| | V-1 | V-2 |
|---|---|---|
| Impact, RT | | |
| Maximum load, kN | 0.094 | 0.084 |
| Energy to F, J | 2.22 | 2.05 |
| Normalized energy at Max, J/mm | 10.53 | 9.71 |
| Normalized energy at F, J/mm | 10.89 | 10.12 |
| Deflection at max load, mm | 41.6 | 42.0 |
| Deflection at F, mm | 42.6 | 43.3 |
| Morphology | Ductile | Ductile |
| Haze | | |
| Haze (dry), % | 14.0 | 13.3 |
| Haze (wet on seal-side), % | 10.4 | 11.0 |
| Haze (wet on both sides), % | 6.6 | 6.7 |

### Multilayer Films Example B

Two different multilayer film configurations were prepared and tested. Examples TPO-3, TPO-4, and TPO-5 included a core layer of rubber-modified polypropylene material and a Cawiton PP/LLDPE/SEBS peel layer. Examples TPO-9, TPO-10, and TPO-11 included tough core layer of rubber-modified polypropylene, a skin layer, a barrier layer, and a tough peel seal layer for a wide range of peel seal applications. The composition of the films is shown in Table 9. Comparative Example A was a currently used five-layer film

TABLE 9
Formulation Data

| | TPO-3 | TPO-4 | TPO-5 | TPO-9 | TPO-10 | TPO-11 |
|---|---|---|---|---|---|---|
| Skin layer | PP Borealis | PP Borealis | PP Borealis | 90% PP | Eastman Ecdel | Eastman Ecdel |
| | RE216CF, 0.5 | RE216CF, 0.5 | RE216CF, 0.5 | Huntsman | PCCE 9966, 0.5 | PCCE 9966, 0.5 |
| | mil | mil | mil | 43M5A/10% | mil | mil |
| | | | | SEBS Kraton | | |
| | | | | G1643, 0.5 mil | | |
| Tie layer | Admer QF300E | Admer QF300E | Bynel 4109, 0.4 | Admer 510, 0.4 | Bynel 4109, 0.4 | Admer 510, 0.4 |
| | 0.4 mil | 0.4 mil | mil | mil | mil | mil |
| Barrier | PA EMS Grilon | PA EMS Grilon | EVOH EVALCA | PA EMS Grilon | PA EMS Grilon | PA EMS Grilon |
| layer | FG40NL, 1.1 mil | FG40NL, 1.1 mil | XEP1107, 1.1 | FG40NL, 1.1 mil | FG40NL, 1.1 mil | FG40NL, 1.1 mil |
| | | | mil | | | |
| Tie layer | Admer QF300E | Admer QF300E | Bynel 4109, 0.4 | Admer 510, 0.4 | Bynel 4109, 0.4 | Admer 510, 0.4 |
| | 0.4 mil | 0.4 mil | mil | mil | mil | mil |
| Core layer | Zelas MC707, 4 | Zelas MC717, 4 | Zelas MC707, 4 | Zelas MC717, 4 | Zelas MC717, 4 | Zelas MC717, 4 |
| | mil | mil | mil | mil | mil | mil |
| Seal layer | PP/PE/SEBS | PP/PE/SEBS | PP/PE/SEBS | 60% PP | 60% PP | 60% PP |
| | Cawiton Med | Cawiton Med | Cawiton Med | Huntsman | Huntsman | Huntsman |
| | PR4581, 1.5 mil | PR4581, 1.5 mil | PR4581, 1.5 mil | 43M5A/15% | 43M5A/15% | 43M5A/15% |
| | | | | LLDPE Exxon | LLDPE Exxon | LLDPE Exxon |
| | | | | LL3003/25% | LL3003/25% | LL3003/25% |
| | | | | SEBS Kraton | SEBS Kraton | SEBS Kraton |
| | | | | G1643, 1.5 mil | G1643, 1.5 mil | G1643, 1.5 mil |

The results of impact testing and haze are shown in Table 10. The results show the films of Examples TPO-3, TPO-4, TPO-9, and TPO-10 had excellent impact toughness. These films also have improved haze values over the film of Comparative Example A, a currently used five-layer film.

TABLE 10
Haze and Impact Data

| | Comparative | | | | | TPO- |
|---|---|---|---|---|---|---|
| | Example A | TPO-3 | TPO-4 | TPO-5 | TPO-9 | 10 |
| Haze | 55.9 | 24.6 | 26.3 | 30.4 | 14.5 | 12.9 |
| (dry), % | | | | | | |
| Haze (wet | 25.8 | 11.6 | 11.8 | 17.8 | 11.4 | 9.3 |
| on seal | | | | | | |
| side), % | | | | | | |
| Maximum | 0.131 | 0.162 | 0.146 | 0.124 | 0.149 | 0.132 |
| load, kN | | | | | | |
| Norm. | 6.64 | 11.30 | 10.80 | 3.20 | 9.80 | 8.40 |
| energy at | | | | | | |
| Max, | | | | | | |
| J/mm | | | | | | |
| Norm. | 6.95 | 11.60 | 11.20 | 3.80 | 10.30 | 9.30 |
| energy at | | | | | | |
| F, J/mm | | | | | | |
| Morphol- | Ductile | Ductile | Ductile | Ductile | Ductile | Ductile |
| ogy | | | | | | |

### Multilayer Films Example C

A series of six-layer film configurations were prepared and tested. In comparison to the previous examples, in these examples the location of the core layer was moved so that it was adjacent to the skin layer. It was believed that locating the core layer to the other side of the barrier layer from the seal layer would help prevent tearing. The configuration of this structure is show in FIG. 3.

The formulations of multilayer films with the configuration shown in FIG. 3 are shown in Tables 11-13. The examples shown include a caprolactam-free nylon as the barrier layer, which is preferred in medical container applications. The results of impact and haze testing of these films are shown in Tables 11-13, respectively. The films NB-3 and NB-4 showed an improvement in haze over the five-layer structure of Comparative Example A. It is also seen that NB-3, which contained a thicker core layer, also showed a significant impact improvement over Comparative Example A. Functional drop testing also showed that NB-3 had a significant drop resistance improvement over Comparative Example A. A multichamber medical container was prepared from the film of NB-3 and was found to not tear at a saw tooth peel seal in the medical container.

TABLE 11

| | Comparative | | | | |
|---|---|---|---|---|---|
| | Commercial | | | | |
| | film | NylonBlend-3 | NylonBlend-4 | CaproFree 4 | CaproFree-8 |
| Film Structure | | | | | |
| Skin Layer | | 90% Huntsman | 90% Huntsman 43M5A/ | 50% Huntsman | 45% Huntsman |
| | | 43M5A/ | 10% Kraton G1643, | P4G3Z-050F/ | P4G3Z-050F/ |
| | | 10% Kraton | 1.8 mil | 50% Zelas | 50% Zelas MC717/ |
| | | G1643, | | MC717, | 5% Profax PF611, 1 |
| | | 0.5 mil | | 0.5 mil | mil |
| Tough Layer | | 83% | 83% Vistamaxx1100/ | 77% Vistamaxx 6102/ | |
| | | Vistamaxx1100/ | 17% Huntsman 43M5A, | 4% Kraton G1643/ | |
| | | 17% Huntsman | 2.2 mil | 19% Huntsman XO1462, | |
| | | 43M5A, | | 4 mil | |
| | | 4 mil | | | |
| Tie Layer | | ADMER QB510A, | ADMER QB510A, | Modic P604V, | |
| | | 0.4 mil | 0.5 mil | 0.4 mil | |
| Barrier Layer | | EMS BM20SBG, | EMS BM20SBG, 1.5 mil | 85% EMS Grilon BM20SBG/15% | |
| | | 1.1 mil | | Grivory HB7103, 1.1 mil | |
| Tie Layer | | ADMER QB510A, | ADMER QB510A, | Modic P604V, | |
| | | 0.4 mil | 0.5 mil | 0.4 mil | |
| Seal Layer | | 25% Kraton | 25% Kraton G1643/ | 70% Huntsman | 70% Huntsman |
| | | G1643/ | 60% Huntsman 43M5A/ | XO1462/ | XO1462/ |
| | | 60% Huntsman | 15% EXXON LL3003, | 22.5% Kraton | 22.5% Kraton |
| | | 43M5A/ | 1.5 mil | G1643/ | G1643/ |
| | | 15% EXXON | | 7.5% | 7.5% Dowlex |
| | | LL3003, | | Dowlex2247G, | 2247G, |
| | | 1.5 mil | | 1.4 mil | 2 mil |
| Tensile, TD | | | | | |
| Young′s | 96.5 (1.4) | 49.2 (0.7) | 64.6 (1.1) | 30.0 (5.3) | 40.1 (0.9) |
| modulus, kpsi | | | | | |
| Modulus (2% | 68.5 (3.7) | 42.6 (4.4) | 56.3 (3.1) | 26.7 (3.8) | 37.2 (0.9) |
| secant), kpsi | | | | | |
| Yield strength, | 3526 (16) | 2048 (15) | 2722 (32) | 1373 (42) | 1766 (18) |
| psi | | | | | |
| Yield | 23.8 (0.4) | 31.0 (0.8) | 58.5 (0.4) | 19.1 (4.8) | 20.5 (1.2) |
| elongation, % | | | | | |
| Tensile | 5620 (144) | 3780 (310) | 4704 (285) | 3318 (76) | 3405 (134) |
| strength, psi | | | | | |
| Tensile | 467 (30) | 520 (45) | 522 (25) | 563 (13) | 513 (25) |
| elongation, % | | | | | |
| Impact, RT | | | | | |
| Maximum load, | 0.13 (0.00) | 0.13 (0.01) | 0.14 (0.00) | 0.118 (0.00) | 0.124 (0.004) |
| kN | | | | | |
| Energy to F, J | 1.29 (0.04) | 1.92 (0.31) | 1.46 (0.07) | 1.9 (0.1) | 1.39 (0.10) |
| Norm. energy | 6.2 (0.8) | 8.2 (1.6) | 6.2 (0.4) | 8.9 (0.5) | 6.0 (0.4) |
| at Max, J/mm | | | | | |
| Norm. energy | 6.8 (0.2) | 8.5 (1.4) | 6.4 (0.3) | 9.1 (0.5) | 6.2 (0.4) |
| at F, J/mm | | | | | |
| Deflection at | 17.8 (1.0) | 24.8 (3.3) | 18.9 (0.8) | 26.4 (1.1) | 21.0 (1.3) |
| max load, mm | | | | | |
| Deflection at F, | 19.0 (0.2) | 25.4 (2.7) | 19.4 (0.8) | 26.9 (1.0) | 21.4 (1.1) |
| mm | | | | | |
| Morphology | Ductile | Ductile | Ductile | 5/5 Ductile | 5/5 Ductile |
| Haze | | | | | |
| Haze (dry), % | 52.7 (0.2) | 21.9 (0.0) | 22.1 (0.0) | 16.1 (0.0) | 16.2 (0.0) |
| Haze (wet on | 47.6 (1.2) | 18.6 (0.2) | 19.4 (0.2) | 13.5 (0.3) | 13.1 (0.0) |
| seal-side), % | | | | | |
| Haze (wet on | 11.8 (0.5) | 12.4 (0.1) | 12.7 (0.1) | 8.8 (0.1) | 10.1 (0.0) |
| both sides), % | | | | | |

TABLE 12

| | CaproFree-9 | CaproFree-10 | CaproFree-11 | CaproFree-12 | CaproFree-17 |
|---|---|---|---|---|---|
| Film Structure | | | | | |
| Skin Layer | 65% Huntsman | PP Hunstman | 45% Huntsman P4G3Z-050F/ | | |
| | P4G3Z-050F/ | 43M5A, | 50% Zelas MC717/ | | |
| | 35% Infuse 9007, | 1.5 mil | 5% Profax PF611, | | |
| | 1 mil | | 1 mil | | |
| Tough | 77% Vistamaxx | 62.5% Vistamaxx 6102/ | | 77% Vistamaxx 6102/ | |
| Layer | 6102/ | 25% Zelas MC717/ | | 4% Kraton G1643/ | |
| | 4% Kraton G1643/ | 12.5% Huntsman XO1462, | | 19% Huntsman XO1462, | |
| | 19% Huntsman | 4 mil | | 4 mil | |
| | XO1462, 4 mil | | | | |
| Tie Layer | Modic P604V, 0.4 mil | | | | |
| Barrier | 85% EMS Grilon BM20SBG | | | | 90% EMS Grilon |
| Layer | 15% Grivory HB7103, | | | | BM20SBG/ |
| | 1.1 mil | | | | 10% Grivory HB7103, |
| | | | | | 1.1 mil |
| Tie Layer | Modic P604V, 0.4 mil | | | | |
| Seal Layer | 70% Huntsman XO1462/ | | | 75% Huntsman | 70% Huntsman PP |
| | 22.5% Kraton G1643/ | | | X01462/ | (R&D Sample (071114- |
| | 7.5% Dowlex2247G, | | | 25% Versify DE3300, 2 | 0896-2))/ |
| | 2 mil | | | mil | 22.5% Kraton G1643/ |
| | | | | | 7.5% Dowlex2247G, |
| | | | | | 2 mil |
| Tensile, TD | | | | | |
| Young′s | 45.8 (4.6) | 53.7 (5.5) | 33.2 (3.0) | 37.5 (3.6) | 49.6 (2.6) |
| modulus, | | | | | |
| kpsi | | | | | |
| Modulus | 41.6 (3.7) | 46.8 (4.6) | 31.3 (2.0) | 34.9 (1.8) | 43.3 (2.4) |
| (2% secant), | | | | | |
| kpsi | | | | | |
| Yield | 1726 (70) | 1909 (101) | 1553.0 (73.0) | 1682.0 (89.0) | 1777 (55) |
| strength, | | | | | |
| psi | | | | | |
| Yield | 15.6 (3.3) | 13.8 (0.6) | 20.3 (1.7) | 19.8 (2.1) | 13.3 (1.2) |
| elongation, % | | | | | |
| Tensile | 3146 (164) | 3480 (22) | 3188.0 (218.3) | 3304.0 (226.3) | 3443 (220) |
| strength, | | | | | |
| psi | | | | | |
| Tensile | 501 (49) | 518 (17) | 515.0 (36.4) | 505.0 (61.6) | 505 (41) |
| elongation, % | | | | | |
| Impact, RT | | | | | |
| Maximum | 0.123 (0.002) | 0.126 (0.00) | 0.119 (0.003) | 0.12 (0.00) | 0.114 (0.002) |
| load, kN | | | | | |
| Energy to | 1.36 (0.15) | 1.19 (0.03) | 1.52 (0.14) | 1.37 (0.13) | 1.37 (0.08) |
| F, J | | | | | |
| Norm. | 6.2 (0.7) | 5.4 (0.1) | 7.6 (0.7) | 6.5 (0.6) | 5.8 (0.4) |
| energy at | | | | | |
| Max, J/mm | | | | | |
| Norm. | 6.3 (0.7) | 5.7 (0.2) | 7.8 (0.7) | 6.8 (0.6) | 6.5 (0.4) |
| energy at | | | | | |
| F, J/mm | | | | | |
| Deflection | 20.6 (1.7) | 18.2 (0.73) | 23.4 (1.6) | 21.7 (1.46) | 20.0 (0.9) |
| at max | | | | | |
| load, mm | | | | | |
| Deflection | 21.0 (1.5) | 18.8 (0.81) | 23.9 (1.5) | 22.3 (1.23) | 21.7 (0.8) |
| at F, mm | | | | | |
| Morphology | 5/5 Ductile | 5/5 Ductile | 5/5 Ductile | 5/5 Ductile | 5/5 Ductile |
| Haze | | | | | |
| Haze (dry), % | 25.4 (0.0) | 27.2 (0.1) | 14.3 (0.0) | 25.1 (0.1) | 11.1 (0.0) |
| Haze (wet | 23.2 (0.0) | 25.3 (0.0) | 10.9 (0.0) | 17.1 (0.1) | 9.0 (0.0) |
| on seal- | | | | | |
| side), % | | | | | |
| Haze (wet | 10.5 (0.1) | 9.9 (0.0) | 7.6 (0.0) | 13.8 (0.1) | 7.0 (0.0) |
| on both | | | | | |
| sides), % | | | | | |

TABLE 13

| | CaproFree- | | | |
|---|---|---|---|---|
| | 18 | CaproFree-19 | CaproFree-20 | CaproFree-21 |
| Film Structure | | | | |
| Skin Layer | 45% Huntsman P4G3Z-050F/ | | | 90% Huntsman |
| | 50% Zelas MC717/ | | | XO1466/ |
| | 5% Profax PF611, | | | 10% Kraton |
| | 1 mil | | | G1643, |
| | | | | 1.0 mil |
| Tough Layer | 77% | 62.5% | 77% Vistamaxx | 77% Vistamaxx |
| | Vistamaxx | Vistamaxx 6102/ | 6102/ | 6102/ |
| | 6102/ | 25% Zelas | 4% Kraton | 4% Kraton |
| | 4% Kraton | MC717/ | G1643/ | G1643/ |
| | G1643/ | 12.5% | 19% Huntsman | 19% Huntsman |
| | 19% | Huntsman | XO1462, | XO1466, |
| | Huntsman | XO1462, | 4 mil | 4 mil |
| | XO1462, | 4 mil | | |
| | 4 mil | | | |
| Tie Layer | Modic P604V, | | ADMER | Modic P604V, |
| | 0.4 mil | | QB510A, 0.2 mil | 0.4 mil |
| Barrier Layer | 87.5% EMS | 90% EMS Grilon | 87.5% EMS Grilon BM20SBG/ | |
| | Grilon | BM20SBG/ | 12.5% Grivory HB7103, | |
| | BM20SBG/ | 10% Grivory | 1.1 mil | |
| | 12.5% Grivory | HB7103, | | |
| | HB7103, | 1.1 mil | | |
| | 1.1 mil | | | |
| Tie Layer | Modic P604V, | | ADMER | Modic P604V, |
| | 0.4 mil | | QB510A, 0.2 mil | 0.4 mil |
| Seal Layer | 70% Huntsman XO1462/ | | | 70% Huntsman |
| | 22.5% Kraton G1643/ | | | XO1466/ |
| | 7.5% Dowlex2247G, | | | 22.5% Kraton |
| | 2 mil | | | G1643/ |
| | | | | 7.5% |
| | | | | Dowlex2247G, |
| | | | | 2 mil |
| Tensile, TD | | | | |
| Young's | 51.9 (2.6) | 44.8 (0.3) | 54.4 (2.2) | 67.1 (1.4) |
| modulus, kpsi | | | | |
| Modulus (2% | 46.0 (2.2) | 39.6 (0.3) | 48.1 (1.5) | 48.2 (4.4) |
| secant), kpsi | | | | |
| Yield strength, | 1862 (62) | 1713 (17) | 1992.0 (51.7) | 2221 (35) |
| psi | | | | |
| Yield | 11.6 (0.5) | 14.1 (0.6) | 13.0 (0.3) | 14.7 (0.5) |
| elongation, % | | | | |
| Tensile | 3206 (133) | 3542 (87) | 3676 (90) | 3904 (153) |
| strength, psi | | | | |
| Tensile | 443 (18) | 525 (19) | 500.0 (12.5) | 508 (44) |
| elongation, % | | | | |
| Impact, RT | | | | |
| Maximum load, | 0.123 (0.006) | 0.114 (0.004) | 0.137 (0.002) | 0.125 (0.000) |
| kN | | | | |
| Energy to F, J | 1.41 (0.11) | 1.38 (0.17) | 1.67 (0.31) | 1.49 (0.06) |
| Norm. energy | 5.8 (0.7) | 6.0 (1.1) | 6.9 (1.6) | 6.0 (0.2) |
| at Max, J/mm | | | | |
| Norm. energy | 6.4 (0.5) | 6.6 (0.8) | 7.3 (1.3) | 6.3 (0.2) |
| at F, J/mm | | | | |
| Deflection at | 20.0 (1.6) | 21.5 (2.7) | 22.3 (3.0) | 20.7 (0.0) |
| max load, mm | | | | |
| Deflection at F, | 21.3 (0.8) | 22.8 (2.2) | 23.1 (2.4) | 21.4 (0.0) |
| mm | | | | |
| Morphology | 5/5 Ductile | 5/5 Ductile | 5/5 Ductile | 5/5 Ductile |
| Haze | | | | |
| Haze (dry), % | 12.7 (0.0) | 13.2 (0.0) | 13.8 (0.0) | 14.9 (0.1) |
| Haze (wet on | 11.2 (0.0) | 11.0 (0.0) | 11.6 (0.0) | 13.2 (0.0) |
| seal-side), % | | | | |
| Haze (wet on | 7.2 (0.0) | 7.2 (0.0) | 7.6 (0.0) | 10.0 (0.0) |
| both sides), % | | | | |

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A multilayer film comprising:
a skin layer;
a seal layer; and
a core layer disposed between the skin layer and the seal layer, the core layer comprising at least one material selected from a rubber-modified polypropylene and a polymer blend, the polymer blend comprising an elastomeric propylene-ethylene copolymer and at least one component selected from the group consisting of polypropylene random copolymer, styrene/ethylene-butylene/styrene block copolymer, and combinations thereof.

2. The multilayer film of claim 1, wherein the core layer comprises a polymer blend comprising about 70% to about 85% by weight of the elastomeric propylene-ethylene copolymer and about 15% to about 30% by weight of the component selected from the group consisting of polypropylene random copolymer, styrene/ethylene-butylene/styrene block copolymer, and combinations thereof.

3. The multilayer film of claim 1, wherein the core layer comprises a rubber-modified polypropylene.

4. The multilayer film of claim 1, wherein the multilayer film has a dart normalized impact energy greater than 6 J/mm according to ASTM D3763.

5. The multilayer film of claim 1, wherein the multilayer film has less than 20% haze when wetted on a first side.

6. The multilayer film of claim 1, wherein the multilayer film can be heat sealed into a container having seals wherein the seals remain intact when the container is autoclaved at 121° C. for one hour.

7. The multilayer film of claim 1, wherein the multilayer film provides a peel seal strength between 4 N/15 mm and 30 N/15 mm.

8. The multilayer film of claim 1, wherein the skin layer comprises at least one component selected from the group consisting of polypropylene random copolymers, polypropylene homo-polymers, nylon, styrene/ethylene-butylene/styrene block copolymers, copolyester ether block copolymers, and combinations thereof.

9. The multilayer film of claim 8, wherein the skin layer comprises a blend comprising about 90% by weight polypropylene random copolymer and about 10% by weight styrene/ethylene-butylene/styrene block copolymer.

10. The multilayer film of claim 8, wherein the skin layer comprises copolyester ether block copolymer.

11. The multilayer film of claim 1, wherein the seal layer comprises at least one component selected from polypropylene random copolymers, linear low-density polyethylenes, styrene/ethylene-butylene/styrene block copolymers, rubber-modified polypropylenes, and mixtures thereof.

12. The multilayer film of claim 1, wherein the seal layer comprises a blend of polypropylene random copolymer, linear low-density polyethylene, and styrene/ethylene-butylene/styrene block copolymer.

13. The multilayer film of claim 1 further comprising a barrier layer disposed between the skin layer and the seal layer.

14. The multilayer film of claim 13, wherein the barrier layer comprises at least one component selected from the group consisting of polyamide 6, polyamide 6,6/6,10 copolymers, amorphous polyamides, ethylene vinyl alcohol copolymers, and combinations thereof.

15. The multilayer film of claim 14, wherein the barrier layer comprises a polyamide.

16. The multilayer film of claim 13, wherein the barrier layer comprises an ethylene vinyl alcohol copolymer.

17. The multilayer film of claim 13, wherein the multilayer film provides a CO₂ permeability of less than 200 cm³/m² day atm.

18. The multilayer film of claim 13 further comprising a first tie layer and a second tie layer, wherein the barrier layer is disposed between and in contact with the first tie layer and the second tie layer.

19. The multilayer film of claim 18, wherein the first and second tie layers each comprises a component selected from the group consisting of maleated LLDPE, maleated polypropylene homopolymer, maleated polypropylene copolymer, maleated thermoplastic elastomer, rubber modified polypropylene, and combinations thereof.

20. A multilayer film comprising:
a skin layer;
a first tie layer;
a barrier layer disposed adjacent the first tie layer;
a second tie layer disposed adjacent the barrier layer;
a core layer comprising a material selected from a rubber-modified polypropylene and a polymer blend, the polymer blend comprising an elastomeric propylene-ethylene copolymer and at least one component selected from the group consisting of polypropylene random copolymer, styrene/ethylene-butylene/styrene block copolymer, and combinations thereof; and
a seal layer.

21. The multilayer film of claim 20, wherein the core layer is disposed adjacent to and in contact with the seal layer.

22. The multilayer film of claim 20, wherein the core layer is disposed adjacent to and in contact with the skin layer.

23. The multilayer film of claim 20, wherein the core layer comprises a rubber-modified polypropylene.

24. The multilayer film of claim 20, wherein the core layer comprises a polymer blend comprising about 70% to about 85% by weight of the elastomeric propylene-ethylene copolymer and about 15% to about 30% by weight of the component selected from the group consisting of polypropylene random copolymer, styrene/ethylene-butylene/styrene block copolymer, and combinations thereof.

25. The multilayer film of claim 20, wherein the skin layer comprises at least one component selected from the group consisting of polypropylene random copolymers, polypropylene homopolymers, polyamides, styrene/ethylene-butylene/styrene block copolymers, copolyester ether block copolymers, and combinations thereof.

26. The multilayer film of claim 20, wherein the barrier layer comprises at least one component selected from the group consisting of polyamide 6, polyamide 6,6/6,10 copolymers, amorphous polyamides, ethylene vinyl alcohol copolymers, and combinations thereof.

27. The multilayer film of claim 20, wherein the seal layer comprises a blend of polypropylene random copolymer, linear low-density polyethylene, and styrene/ethylene-butylene/styrene block copolymer.

28. The multilayer film of claim 20, wherein the multilayer film has a dart normalized impact energy greater than 6 J/mm according to ASTM D3763.

29. The multilayer film of claim 20, wherein the multilayer film has less than 20% haze when wetted on a first side.

30. The multilayer film of claim 20, wherein the multilayer film can be heat sealed into a container having seals wherein the seals remain intact when the container is autoclaved at 121° C. for one hour.

31. The multilayer film of claim 20, wherein the multilayer film provides a peel seal strength between 4 N/15 mm and 30 N/15 mm.

32. A container comprising a body defined by a film having at least one layer comprising a blend comprising about 70% to about 85% by weight of an elastomeric propylene-ethylene copolymer and about 15% to about 30% by weight of a component selected from the group consisting of polypropylene random copolymers, styrene/ethylene-butylene/styrene block copolymers, and combinations thereof.

33. A container comprising a body defined by a multilayer film comprising:
a skin layer;
a seal layer; and
a core layer disposed between the skin layer and the seal layer, the core layer comprising a material selected from a rubber-modified polypropylene and a polymer blend, the polymer blend comprising an elastomeric propylene-ethylene copolymer and a component selected from the group consisting of polypropylene random copolymers, styrene/ethylene-butylene/styrene block copolymers, and combinations thereof.

34. A container comprising a first sidewall and a second sidewall sealed together along at least one common peripheral edge to define a fluid chamber, wherein at least one of the first and second sidewall comprises a multilayer film comprising:
a skin layer;
a first tie layer;
a barrier layer disposed adjacent the first tie layer;
a second tie layer disposed adjacent the barrier layer;
a core layer comprising a material selected from a rubber-modified polypropylene and a polymer blend, the polymer blend comprising an elastomeric propylene-ethylene copolymer and a component selected from the group consisting of polypropylene random copolymer, styrene/ethylene-butylene/styrene block copolymer, and combinations thereof; and
a seal layer.

35. The container of claim 34, wherein the core layer is disposed between the skin layer and the first tie layer.

36. The container of claim 34, wherein the core layer is disposed between the second tie layer and the seal layer.
